(19) United States
(12) Patent Application Publication
(10) Pub. No.: US 2007/0297158 A1
(43) Pub. Date: Dec. 27, 2007

(54) Front-to-back stacked device

(75) Inventor: Chun-Liang Lee, Taiwan (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/588,781

(22) Filed: Oct. 26, 2006

(30) Foreign Application Priority Data
Jun. 23, 2006 (TW) 095211025

(51) Int. Cl. H01R 12/16

(52) U.S. Cl. 361/790; 361/748; 361/728; 361/735; 361/729

(57) ABSTRACT

A front-to-back stack device is applied to two or more modularized circuit boards, such as two servo module circuit boards in a blade server. Through the use of the stack device, the two servo module circuit boards can be therefore stacked to each other in a front-to-back stacked manner. Compared with prior art, these two servo module circuit boards are capable of having an expanding process function and an output/input capacity. Therefore, the present invention enables the blade server having optimized expansion ability, and evenly forming each slide of servo module circuit board to have an optimized economic costs and benefits

### BACKGROUND OF THE INVENTION

1. Field of the Invention

This invention relates to computer hardware technology, and more particularly, to a front-to-back stacked device which is designed for use to combine two or more modularized circuit boards, such as server module circuit boards in a blade server, in a front-to-back stacked manner into a single functional unit for providing expanded data processing performance and I/O handling capacity.

2. Description of Related Art

A blade server is a clustering type of network server that is characterized by the use of a chassis to accommodate a cluster of server modules (commonly called “blades”), with all of these server modules providing the same server functionality. In other words, a blade server can respond to a client's request by linking any one of the clustered server modules to the client. In practical implementation, each server module is made into a single circuit board (i.e., blade), which can be easily fitted to the blade server's enclosure to increase the blade server's client serving capacity. Moreover, a blade server is typically equipped with a common management control module for controlling all the operations of the multiple server modules and their shared resources in the blade server.

In a blade server, each server module is provided with one or more dedicated processors and I/O controllers. In practical application, the server modules are plugged to the blade server's chassis and operate independently. In some applications, it is required to combine two or more server modules into a single functional unit to provide expanded data processing performance and I/O handling capacity.

Presently, a conventional method for combining multiple server modules is to use a back-to-back stacked device that combine two server modules having different hardware architectures into a single functional unit. One drawback to this method, however, is that since the server modules have different hardware architectures, it would be more complex to design and thus more costly to implement.

Another conventional method for combining multiple server modules is to use a pass-through board for interconnecting server modules of different hardware specifications into a single functional unit. One drawback to this method, however, is that since the server modules in the combined unit are only provided with processors and no I/O controllers, it cannot be used for expanding I/O handling capacity.

One solution to the foregoing problem is to use a special type of server module that has expandable I/O handling capacity. However, since this type of server module is provided with connectors of different specifications, the design of bus connections (such as PCA bus connections) would be very complex and thus difficult to implement. Moreover, since these server modules have different connector specifications, they are classified into different models with different inventory numbers, which make the inventory management troublesome and thus inconvenient.

### SUMMARY OF THE INVENTION

It is therefore an objective of this invention to provide a front-to-back stacked device that allows multiple server modules of the same type to be combined in a front-to-back stacked manner that can help reduce hardware complexity and thus can be more convenient and cost-effective to implement.

It is another objective of this invention to provide a front-to-back stacked device that allows two independent server modules to be combined into a single functional unit having expanded data processing performance and I/O handing capacity.

The front-to-back stacked device according to the invention is designed for use to combine two or more modularized circuit boards, such as two or more server module circuit boards in a blade server, in a front-to-back stacked manner into a single functional unit for providing expanded processing performance and I/O handling capacity.

The front-to-back stacked device of the present invention includes a first modularized circuit board having a first front side and a first back side opposing to the first front side, the first front side being mounted with first hardware circuitry; a second modularized circuit board having a second front side and a second back side opposing to the second front side, the second front side being mounted with second hardware circuitry; and at least one signal interconnecting module having a first connector and a second connector, wherein the first connector is used for connection with the first hardware circuitry of the first modularized circuit board, while the second connector is used for connection with the second hardware circuitry of the second modularized circuit board, for the purpose of allowing the first modularized circuit board and the second modularized circuit board to exchange signals therethrough such that the first modularized circuit board and the second modularized circuit board are combined into a single functional unit; and wherein the first modularized circuit board and the second modularized circuit board are oriented in a front-to-back stacked manner that allows the second front side of the second modularized circuit board to face against the first back side of the first modularized circuit board.

The front-to-back stacked device according to the invention is characterized by the combination of two or more modularized circuit boards of the same hardware architecture having I/O controllers in a front-to-back stacked manner into a single functional unit for offering expanded data processing performance and I/O handling capacity. This feature allows a blade server to have enhanced expandability from the separate and independent server module circuit boards that have identical hardware architecture, such that the implementation and inventory management is more convenient and cost-effective than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a perspective view of the front-to-back stacked device according to the invention.

### DETAILED DESCRIPTION OF PREFERRED EMBODIMENTS

The front-to-back stacked device according to the invention is disclosed in full details by way of preferred embodiments in the following with reference to the accompanying drawings.

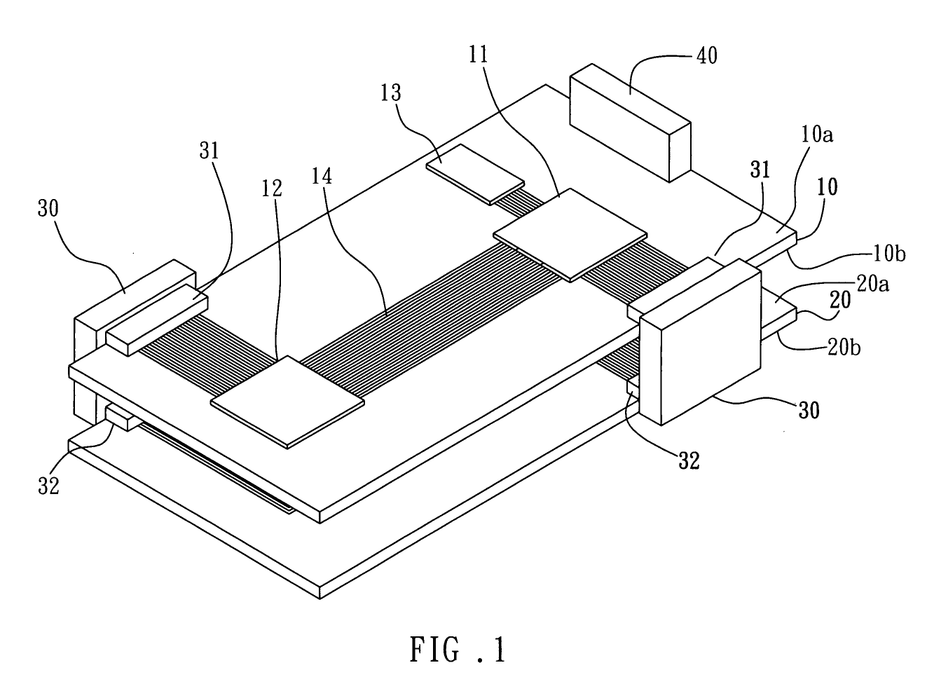

FIG. 1 is a schematic diagram showing a perspective view of a front-to-back stacked device according to the present invention. The front-to-back stacked device comprises a first modularized circuit board 10, a second modularized circuit board 20, and at least one signal interconnecting module 30. Firstly, the respective attributes and functions of the first modularized circuit board 10, the second modularized circuit board 20, and the signal interconnecting module 30 are described in details in the following.

The first modularized circuit board 10 is designed for use, for example, as an independent server module for blade servers. Structurally, the first modularized circuit board 10 has a first front side 10a and a first back side 10b in opposition to the first front side 10a, where the first front side 10a is mounted with first hardware circuitry which is based on, for example, a dual-processor architecture including a first CPU 11 (Central Processing Unit), a second CPU 12, and an I/O (input/output) controller 13, with an I/O bus 14 interconnected between the first CPU 11 and the second CPU 12. In the embodiment of FIG. 1, for example, the first modularized circuit board 10 is a dual-processor circuit board including two CPUs (i.e., the first CPU 11 and the second CPU 12); however, it is to be noted that the number of CPUs and the type of the hardware architecture are unrestricted. In practical implementation, for example, the I/O bus 14 has a fixed I/O handling capacity (i.e., the number of peripheral devices that can be connected thereto), and is a HT (HyperTranser) type of I/O bus. Beside, in the case of the first modularized circuit board 10 being a server module circuit board, it further includes a system main control unit connector 40 for connection to a blade server's system main control unit (not shown).

The second modularized circuit board 20 is identical in architecture to the aforementioned first modularized circuit board 10 for use as an independent server module in a blade server. Similarly, the second modularized circuit board 20 has a second front side 20a and a second back side 20b in opposition to the second front side 20a, where the second front side 20a is mounted with second hardware circuitry which is based on a dual-processor architecture (not shown).

The signal interconnecting module 30 is implemented with a pass-through board which includes a first connector 31 and a second connector 32. The first connector 31 is used for connection with the HT bus 14 on the first modularized circuit board 10, while the second connector 32 is used for connection with the HT bus (not shown) on the second modularized circuit board 20. This connection allows the first modularized circuit board 10 and the second modularized circuit board 20 to exchange signals through the signal interconnecting module 30 such that the first modularized circuit board 10 and the second modularized circuit board 20 can be combined into a single functional unit. In actual application, it is preferred to use two signal interconnecting modules 30 for interconnecting the first modularized circuit board 10 and the second modularized circuit board 20 in a front-to-back stacked manner so that the signal transmissions therebetween can be made more reliable. Moreover, it is an essential aspect of the invention that the first modularized circuit board 10 and the second modularized circuit board 20 are oriented in a front-to-back stacked manner that allows the second front side 20a (where the second hardware circuitry includes CPU, I/O controller, and I/O bus are mounted) of the second modularized circuit board 20 to face against the first back side 10b of the first modularized circuit board 10.

The following is a detailed description of a practical application example of the front-to-back stacked device of the invention. In this application example, it is assumed that the first modularized circuit board 10 and the second modularized circuit board 20 are each a dual-processor circuit board having an I/O handling capacity of N peripheral devices.

In normal applications, the first modularized circuit board 10 and the second modularized circuit board 20 can be respectively employed for use as a single, independent server module for installation on a blade server, each capable of offering a 2-processor data processing performance and an I/O handling capacity of N peripheral devices.

When it is needed to use a server module that has a 4-processor data processing performance and an I/O handling capacity of 2N peripheral devices, the system management personnel can simply use the signal interconnecting module 30 (i.e., a pass-through board) to interconnect the first modularized circuit board 10 with the second modularized circuit board 20 in a front-to-back stacked manner, wherein the first connector 31 of the signal interconnecting module 30 is connected to the HT bus 14 on the first modularized circuit board 10, while the second connector 32 is connected to the HT bus (not shown) on the second modularized circuit board 20. This front-to-back stacked interconnection allows the first modularized circuit board 10 and the second modularized circuit board 20 to exchange signals through the signal interconnecting module 30, thus acting as a single functional unit that can offer a doubled performance, i.e., a 4-processor data processing performance and an I/O handling capacity of 2N peripheral devices.

In conclusion, the invention provides a front-to-back stacked device which is characterized by the combination of two or more modularized circuit boards of the same hardware architecture having I/O controllers in a front-to-back stacked manner into a single functional unit for offering expanded data processing performance and I/O handling capacity. This feature allows a blade server to have enhanced expandability from the separate and independent server module circuit boards that have identical hardware architecture, such that the implementation and inventory management is more convenient and cost-effective than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A front-to-back stacked device, which comprises:
a first modularized circuit board having a first front side and a first back side opposing to the first front side, the first front side being mounted with first hardware circuitry;
a second modularized circuit board having a second front side and a second back side opposing to the second front side, the second front side being mounted with second hardware circuitry; and
at least one signal interconnecting module, which includes a first connector and a second connector, wherein the first connector is used for connection with the first hardware circuitry of the first modularized circuit board, while the second connector is used for connection with the second hardware circuitry of the second modularized circuit board, for the purpose of allowing the first modularized circuit board and the second modularized circuit board to exchange signals therethrough such that the first modularized circuit board and the second modularized circuit board are combined into a single functional unit; and wherein the first modularized circuit board and the second modularized circuit board are oriented in a front-to-back stacked manner that allows the second front side of the second modularized circuit board to face against the first back side of the first modularized circuit board.

2. The front-to-back stacked device of claim 1, wherein the first modularized circuit board and the second modularized circuit board are each a server module circuit board for a blade server.

3. The front-to-back stacked device of claim 1, wherein the first modularized circuit board and the second modularized circuit board are each a dual-processor circuit board.

4. The front-to-back stacked device of claim 1, wherein the first modularized circuit board and the second modularized circuit board are each installed with a HT (HyperTransfer) type of input/output bus.

5. The front-to-back stacked device of claim 1, wherein the first modularized circuit board includes a system main control unit connector.
